(19) United States
(12) Patent Application Publication
(10) Pub. No.: US 2006/0026942 A1
(43) Pub. Date: Feb. 9, 2006

(54) Manually guided implement having an adjustable handle

(75) Inventors: Ralf-Rainer Kemmler, Schwaikheim (DE); Johannes Menzel, Wernau (DE)

Correspondence Address: ROBERT W. BECKER & ASSOCIATES, Suite B, 707 Highway 66 East, Tijeras, NM, 87059, US

(73) Assignee: Andreas Stihl AG & Co. KG, Waiblingen (DE)

(21) Appl. No.: 11/196,614

(22) Filed: Aug. 3, 2005

(30) Foreign Application Priority Data
Aug. 3, 2004 (DE) 10 2004 037 510.0

(51) Int. Cl. A01D 34/03

(52) U.S. Cl. 56/17.5

(57) ABSTRACT

A manually guided implement, especially a brush cutter, comprising a guide tube with a guide motor at one end and a tool head that carries a rotatably drivable tool at the opposite end. A handle is disposed on a securement mechanism, and a handle carrier is disposed between the securement mechanism and the guide tube. The handle carrier is fixed in position on the guide tube along a short range relative to the longitudinal direction of the guide tube. The securement mechanism is adjustably held on the handle carrier such that the position of the securement mechanism relative to the longitudinal direction is adjustable.

### BACKGROUND OF THE INVENTION

The present invention relates to a portable or manually-guided implement.

Manually-guided implements, such as brush cutters, edgers or the like, and having a guide tube, on one end of which is disposed a drive motor and on the opposite end of which is disposed a tool head having a rotatably drivable tool, are subjected to oscillation or vibration loads during operation that are sensed as vibrations at the handles of the implement. The guide tube also tends to oscillate during operation, with such oscillations being induced by the drive motor and/or by the rotating cutting tool.

For a precise guidance of the implement, disposed on the guide tube, in the vicinity of the center of gravity of the implement, is a handle to which the oscillations of the guide tube are transferred. U.S. Pat. No. 6,536,117 discloses an implement where the handle is secured to the guide tube by means of a securement mechanism in such a way that the position of the securement mechanism is adjustable relative to a longitudinal direction of the guide tube. The operator can select a securement position of the securement mechanism with the handle that enables an ergonomically favorable holding of the handle. However, the selected ergonomically favorable position can be disposed in the range of an oscillation loop of the guide tube, which has been caused to oscillate, as a result of which an undesirable high vibration occurs at the handle.

It is therefore an object of the present application to provide a manually-guided implement that has a reduced vibration level at the handle.

### BRIEF DESCRIPTION OF THE DRAWINGS

This object, and other objects and advantages of the present invention, will appear more clearly from the following specification in conjunction with the accompanying schematic drawings, in which:

FIG. 1 shows an overview of a manually-guided implement, for example a brush cutter;

FIG. 2 is a side view of the brush cutter of FIG. 1, with an oscillation line being indicated;

FIG. 3 is an enlarged illustration of a section of the guide tube of FIG. 2 having an adjustable handle carrier disposed thereon;

FIG. 4 schematically illustrates one embodiment of a securement of the handle carrier on the guide tube, via an annular knife-edge element, that is radially rigid and yielding in the tilt direction;

FIG. 5 shows a variation of the arrangement of FIG. 4 with a radially rigid, semi-elastic element that is yielding in the tilt direction; and

FIGS. 6 shows a further variation of the arrangement of FIGS. 4 and 5 with an approximately circular disk-shaped base of the carrier tube that is yielding transverse to its plane.

### SUMMARY OF THE INVENTION

The manually guided implement of the present application is characterized in that provided between the securement mechanism of the handle and the guide tube is a handle carrier that is fixed in position on the guide tube along a short range relative to the longitudinal direction of the guide tube, whereby the securement mechanism is held on the handle carrier such that it is adjustable in the longitudinal direction. The short securement portion of the handle carrier can be secured in the range of an oscillation node of the guide tube that is caused to oscillate, whereby the remaining regions of the handle carrier are not in a dynamic reciprocal action with the oscillating guide tube. The short securement portion, which is disposed in the range of the oscillation node, is subjected to no or only a slight oscillation excitation, as a consequence of which during the operation of the implement the handle carrier is on the whole at least nearly free of vibrations. The securement mechanism of the handle can be displaced on the handle carrier, relative to the longitudinal direction of the guide tube, within a prescribed adjustment range. An ergonomically favorable grasping position can be established, and can be adapted to various operators, without the selection of a changed adjustment position increasing the vibration level at the handle. The vibration level at the handle remains constantly low over the entire adjustment range in conformity with the low excitation in the oscillation node.

Pursuant to an advantageous further development, the handle carrier has a length that extends in the longitudinal direction of the guide tube. In this connection, relative to its length, one end of the handle carrier is fixed in position on the guide tube via a securement portion, while the remaining region, up to its opposite end, is radially spaced from the guide tube. This ensures that a mechanical connection of the handle carrier with the guide tube is provided merely in the short securement portion. The securement portion can be disposed in the region of an oscillation node, or at least in a region of low oscillation excitation of the guide tube, while the remaining region of the handle carrier is isolated from the guide tube with respect to oscillation. For reliable oscillation isolation, a radial spacing of from 1 to 2 mm has been shown to be expedient.

An elastically yielding damping element is advantageously disposed between the guide tube and the free end of the handle carrier that is opposite the securement portion thereof. Residual oscillations transferred between the guide tube and the carrier can be effectively dampened. With a large axial distance between the handle and the securement portion of the handle carrier, the damping element can exert an additional support effect, as a result of which an excessive elastic relative deflection of the handle carrier relative to the guide tube is avoided. The precision of guidance of the implement is improved.

Pursuant to an advantageous further development, the handle carrier is essentially rigidly secured on the guide tube in the radial direction, and in a tilt direction that is transverse thereto it is relatively yieldingly secured. The rigid securement in the radial direction leads to a high precision of guidance of the implement. The yielding securement in the tilt direction permits the unobstructed formation of an oscillation form of the guide tube, whereby the bending line of the respective oscillation form at the site of the securement can assume a tilting angular position relative to the handle carrier. A transfer of the oscillating tilt movement to the handle carrier is avoided or at least reduced due to the securement that is yielding in the tilt direction.

Pursuant to an expedient embodiment, the handle carrier is in the form of a carrier tube that coaxially extends around the guide tube. In this connection, the interposed damping element is advantageously embodied as a sealing element that surrounds the guide tube. A compact, heavy-duty construction results. With strong manual forces, the defined radial spacing of the carrier tube, together with the damping element or sealing element, prevents an excessive elastic relative deformation in all radial directions. The sealing element prevents dirt from penetrating into the space between the carrier tube and the guide tube. An impairment of a free oscillation of the guide tube relative to the at least nearly oscillation-free carrier tube is permanently reliably avoided.

Pursuant to an advantageous further development, a securement position of the handle carrier is adjustable in the longitudinal direction of the guide tube. It has been shown that during operation of the implement with various cutting tools of different masses, the guide tube respectively assumes its own characteristic oscillation form. Oscillation nodes develop at locations of the guide tube as a function of the tool that is selected. A respective marking is expediently provided at one or more of the oscillation nodes that develop during operation. The operator can shift the handle carrier along the guide tube in such a way that the securement portion of the handle carrier is disposed and secured in the region of the respectively developing oscillation node, i.e. at the pertaining marking.

Further specific features of the present application will be described in detail subsequently.

### Description of Specific Embodiments

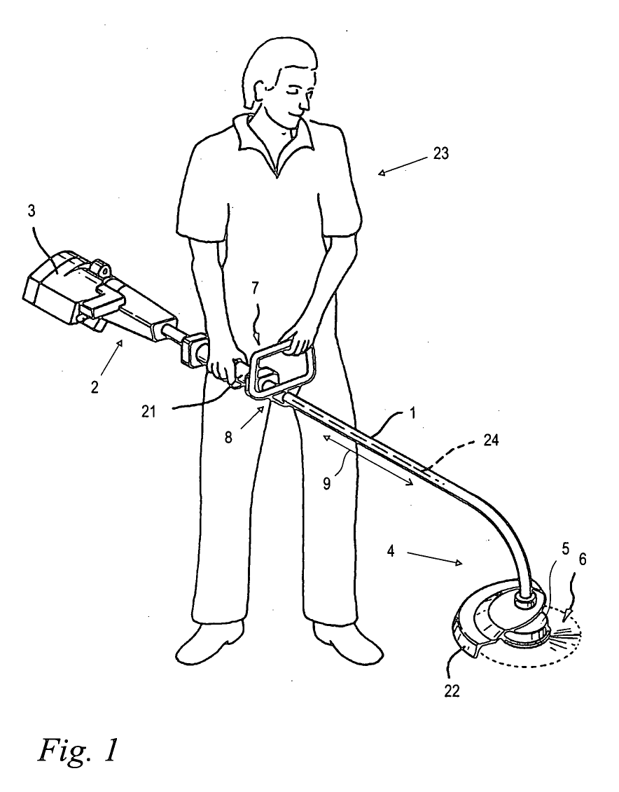

Referring now to the drawings in detail, FIG. 1 is an overall view of a manually-guided or portable implement, for example a brush cutter, having an elongated guide tube 1 that tends to oscillate or vibrate. Disposed at one end 2 of the guide tube is a drive motor 3 which, by means of a drive shaft 24 that extends within the guide tube 1, drives a rotatable cutting tool 6. The cutting tool is held on a tool head 5 and is partially covered by means of a protective cover 22. The tool head 5 with the cutting tool 6 is disposed at the opposite end 4 of the guide tube 1.

Two handles 7, 21 are provided, whereby the rear handle 21 is disposed in the vicinity of the drive motor 3, and the front handle 7 is secured to the guide tube 1 via a securement mechanism 8. The position of the securement mechanism 8 together with the front handle 7 is adjustable relative to a longitudinal direction 9 of the guide tube 1. The adjustability of the securement mechanism 8 is provided so that an operator 23 can select an ergonomically favorable position of the handle 7 for gripping and guiding the implement.

Instead of the brush cutter illustrated by way of example, it is also possible to provide a comparable implement having a similar elongated guide tube 1, such as an edger, a pole pruner, or the like.

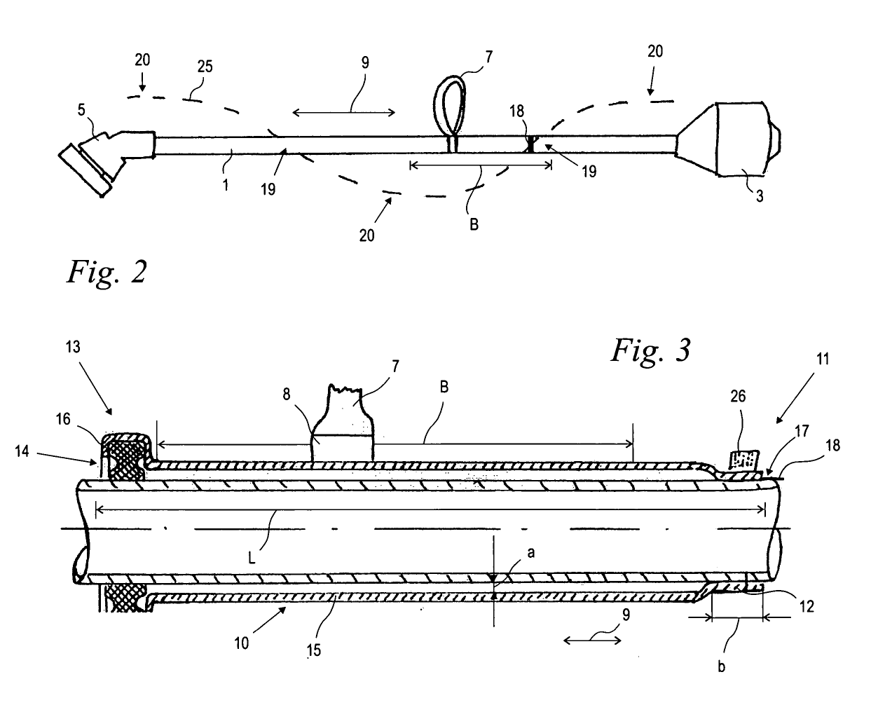

The schematic side view of the brush cutter of FIG. 1 is shown in FIG. 2 with the guide tube 1, the drive motor 3, and the tool head 5. When excited by vibrations of the drive motor 3 and/or of the tool head 5, the guide tube 1 can oscillate in the form of, for example, an oscillation line 25. A standing wave results in the form of the oscillation line 25 having oscillation loops 20 and oscillation nodes 19. By means of the securement mechanism 8, which is shown in greater detail in FIG. 3, the front handle 7 is adjustable in the longitudinal direction 9 of the guide tube 1 over a range B, whereby this range B spans at least one oscillation node 19 as well as a portion of an oscillation loop 20.

A marking 18 is provided at that oscillation node 19 that is closer to the motor and develops during operation of the implement. If the cutting tool 6 (FIG. 1) is replaced with a cutting tool having a different mass, a different course of the oscillation line 25, along with a different position of the oscillation nodes 19, can develop. It can therefore be expedient to provide a corresponding number of markings 18 in the region of different positions of the oscillation nodes 19.

The enlarged detailed view of FIG. 3 shows a section of the guide tube 1 of FIG. 2 in the region of the front handle 7. Provided between the securement mechanism 8 of the front handle 7 and the guide tube 1 is a handle carrier 10 that, relative to the longitudinal direction 9 of the guide tube 1, is fixed in position on the guide tube along a short range b. For the securement of the handle carrier 10, a clamping mechanism 26 is provided by means of which a securement position 17 of the handle carrier 10 is adjustable relative to the longitudinal direction 9. The securement position 17 is selected directly adjacent to the marking 18 of the guide tube 1, as a result of which a handle carrier 10 is fixed in position at the location of the oscillation node 19 that is closest to the motor (FIG. 2) via a short securement portion 12 that extends over the range b.

The handle carrier 10 has a length L in the longitudinal direction 9 of the guide tube 1. Relative to its length L at one end 11 the handle carrier 10 is fixed in position on the guide tube 1 via the securement portion 12; in the remaining portion of the handle carrier 10, up to its opposite end 13, the handle carrier is radially spaced from the guide tube 1 by the distance a. The handle carrier 10 can be embodied as a bracket or the like, and in the illustrated embodiment is in the form of a carrier tube 15 that surrounds the guide tube 1 essentially coaxially and, with the exception of the short securement portion 12, around the periphery of the guide tube 1 and on the inner side, is spaced therefrom by a distance a that ranges from 1 to 2 mm. The distance a is approximately constant in the longitudinal direction 9, but can also be variable, for example in a conical manner.

Provided at the free end 13 of the handle carrier 10, i.e. opposite the securement portion 12, is an elastically yielding damping element 14 that is disposed between the handle carrier 10 and the guide tube 1. In the illustrated embodiment, the damping element 14 is in the form of a sealing element 16 that surrounds the guide tube 1 and that at the end seals off the free space between the guide tube 1 and the carrier tube 15.

The securement mechanism 8, together with the handle 7, are held on the handle carrier 10 so as to be adjustable in the longitudinal direction 9 over the range B. Manual forces on the front handle 7 are transferred to the guide tube 1 via the securement mechanism 8 and the securement portion 12 of the handle carrier 10, whereby the elastic damping element 14 assumes only a subordinate function during the transfer of force. The elastic damping element 14 permits an elastic relative deformation of the carrier tube 15 in the radial direction relative to the guide tube 1. With excessive manual forces, and corresponding radial deflection of the carrier tube 15, the inner side of the carrier tube comes to rest against the outer side of the guide tube 1, thereby avoiding excessive elastic deflection of the front handle 7.

Regardless of the selected position of the securement mechanism 8 on the handle carrier 10, a mechanical coupling between the handle 7 and the guide tube 1 is essentially limited to the securement position 17. This securement position is disposed in the range of an oscillation node 19 (FIG. 2), as a consequence of which an introduction of vibration from the guide tube 1 into the handle carrier 10, and hence into the front handle 7, at least essentially does not occur. Beyond the short range b that is disposed in the oscillation node 19, the handle carrier 10 is radially spaced from the guide tube 1 by a distance a, as a consequence of which in this region the guide tube 1 can oscillate freely. An oscillation loop 20 (FIG. 2) that develops in this region cannot be transferred to the handle carrier 10, and hence to the handle 7. The damping element 14 has an appropriately soft or resilient form, so that the formation of an oscillation loop 20 is at least essentially unobstructed.

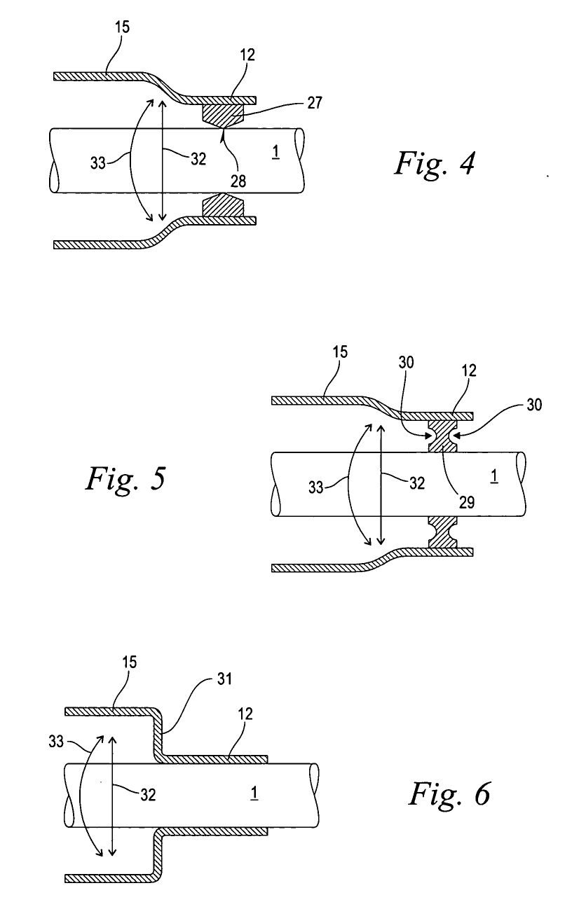

The diagrammatic cross-sectional illustration of FIG. 4 shows a region of the securement portion 12 of the handle carrier 10 (FIG. 3), which is in the form of a carrier tube 15. The tubular securement portion 12 extends around the guide tube 1 and is radially spaced therefrom to form a space that is filled by an annular knife-edge or wedge-shaped element 27. The outer side of the knife-edge element is fixedly connected with the securement portion 12 and the radially inner side rests linearly on the guide tube 1 via a circumferential edge 28. The linear support on the guide tube 1 effects a securement on the guide tube that is essentially rigid in a radial direction as indicated by the double arrow 32, and that is relatively soft or yielding in a tilt direction, which is disposed transverse to the radial direction 32 and is indicated by the double arrow 33. The yielding securement in the tilt direction 33 permits an oscillating angular position of the guide tube 1, in its oscillation node 19 (FIG. 2), relative to the carrier tube 15.

FIG. 5 shows a variation of the arrangement of FIG. 4, according to which an annular and circumferential, semi-elastic element 29 is provided between the securement portion 12 and the guide tube 1. The semi-elastic element 29 can be made of rubber or a comparable elastic material that due to its circumferential arrangement leads to a securement of the carrier tube 15 on the guide tube 1 that is at least nearly rigid in the radial direction 32. Circumferential recesses 30 are provided on both sides, as a result of which the semi-elastic element 29 is relatively soft or yielding transverse to the radial direction 32, in other words transverse to the central plane of the element 29. The yielding configuration in this direction leads to a relatively yielding securement of the carrier tube 15 relative to the tilt direction 33.

FIG. 6 illustrates yet another embodiment, according to which the illustrated end of the carrier tube 15 has an approximately cup-shaped configuration. Disposed between the carrier tube 15 and its securement portion 12 is an approximately circular disk-shaped base 31, whereby the carrier tube 15, the securement portion 12 and the base 31 are monolithically formed. The thin-walled base 31 extends in the radial direction 32, as a result of which, due to its shape, it is essentially rigid in this direction. Transverse to its disk plane, the base 31 bends readily, as a result of which the carrier tube 15 is secured to the guide tube 1 in a relatively yielding manner in the tilt direction 33. The remaining features and reference numerals of the embodiments of FIGS. 4 to 6 coincide with one another and with the embodiment of FIGS. 2 and 3.

The specification incorporates by reference the disclosure of German priority document 10 2004 037 510.0 filed Aug. 3, 2004.

The present invention is, of course, in no way restricted to the specific disclosure of the specification and drawings, but also encompasses any modifications within the scope of the appended claims.

We claim:

1. A manually guided implement, comprising:
a guide tube having a first end with a drive motor and a second, opposite end with a tool head that carries a rotatably drivable tool;
a handle;
a securement mechanism, wherein said handle is disposed on said securement mechanism; and
a handle carrier disposed between said securement mechanism and said guide tube, wherein said handle carrier is fixed in position on said guide tube along a short range relative to a longitudinal direction of said guide tube, and wherein said securement mechanism is adjustably held on said carrier such that a position of said securement mechanism relative to said longitudinal direction of said guide tube is adjustable.

2. An implement according to claim 1, wherein said handle carrier has a length that extends in said longitudinal direction of said guide tube, wherein said handle carrier, relative to its length and at a first end thereof, is adapted to be fixed in position on said guide tube via a securement portion of said handle carrier, and wherein a remaining portion of said handle carrier, up to a second, opposite end thereof, is spaced from said guide tube by a radial distance.

3. An implement according to claim 2, wherein said radial distance is in the range of from 1 to 2 mm.

4. An implement according to claim 2, wherein an elastically yielding damping element is disposed between said guide tube and said second end of said handle carrier that is opposite said securement portion.

5. An implement according to claim 1, wherein in a radial direction said handle carrier is fixed essentially rigidly on said guide tube, and in a tilt direction that is disposed transverse to said radial direction said handle carrier is fixed relatively yieldingly on said guide tube.

6. An implement according to claim 1, wherein said handle carrier is a carrier tube that coaxially surrounds said guide tube.

7. An implement according to claim 4, wherein said damping element is a sealing element that surrounds said guide tube.

8. An implement according to claim 1, wherein a securement position of said handle carrier on said guide tube is adjustable in said longitudinal direction of said guide tube.

9. An implement according to claim 8, wherein a marking is provided on said guide tube at at least one oscillation node that develops during operation of said implement.
